(19) United States
(12) Patent Application Publication
(10) Pub. No.: US 2007/0175826 A1
(43) Pub. Date: Aug. 2, 2007

(54) Method for separating and purifying nucleic acid

(76) Inventors: Rie Iwata, Asaka-shi (JP); Yoshihiko Makino, Asaka-shi (JP)

Correspondence Address: BIRCH STEWART KOLASCH & BIRCH, PO BOX 747, FALLS CHURCH, VA, 22040-0747, US

(21) Appl. No.: 10/593,270

(22) PCT Filed: Mar. 18, 2005
(86) PCT No.: PCT/JP05/05626

§ 371 Date: Sep. 18, 2006

(30) Foreign Application Priority Data
Mar. 25, 2004 (JP) 2004-090392

(51) Int. Cl. B01D 61/24

(52) U.S. Cl. 210/644; 436/178; 435/6

(57) ABSTRACT

A method for separating and purifying a nucleic acid, which comprises: (1) adsorbing the nucleic acid to a nucleic acid adsorbing porous membrane by passing a sample solution containing the nucleic acid through the nucleic acid adsorbing porous membrane; (2) washing the nucleic acid adsorbing porous membrane by passing a washing solution through the nucleic acid adsorbing porous membrane, while the nucleic acid is adsorbed to the nucleic acid adsorbing porous membrane; and (3) desorbing the nucleic acid from the nucleic acid adsorbing porous membrane by passing a recovering solution through the nucleic acid adsorbing porous membrane, wherein the nucleic acid adsorbing porous membrane is a porous membrane that has a contact angle of 60 degree or less after 17 m seconds of contact of the porous membrane with 3 μl of water dropped to the porous membrane.

### TECHNICAL FIELD

This invention relates to a method for separating and purifying nucleic acid. More particularly, the invention relates to a method for obtaining a sample solution containing nucleic acid from an analyte, for separating and purifying nucleic acid. Further preferably, it relates to a method for separating and purifying nucleic acid using the sample solution containing nucleic acid, and using a cartridge for separation and purification of nucleic acid prepared by receiving a nucleic acid adsorbing porous membrane in a container having at least two openings and, as occasion demands, a pressure producing device.

### BACKGROUND ART

Nucleic acid is used in various fields in various forms. For example, in the field of recombinant nucleic acid techniques, nucleic acid is required to be used in the form of a probe, a genomic nucleic acid and a plasmid nucleic acid.

In the field of diagnosis, nucleic acid is also used in various forms for various purposes. For example, nucleic acid probes are generally used for the detection and diagnosis of human pathogens. In the same manner, nucleic acid is used for the detection of hereditary disorders. Nucleic acid is also used for the detection of food pollution substances. In addition, nucleic acid is generally used for the location verification, identification and isolation of the nucleic acid of interest due to various reasons covering from the preparation of genetic map to cloning and recombinant expression.

In most cases, nucleic acid can be obtained only in an extremely small amount, and its isolation and purification operations are complex and require time. This time-consuming complex operations are apt to cause loss of nucleic acid. When nucleic acid is purified from samples prepared from serum, urine and a bacterial culture, dangers of causing contamination and false-positive result are also added.

As one of the broadly known separation purification methods, there is a method in which nucleic acid is adsorbed to silicon dioxide, silica polymer, magnesium silicate or the like solid phase and then separated and purified by carrying out washing, desorption and the like operations (e.g., JP-B-7-51065). This method is excellent in its separation performance, but cannot be said sufficient in terms of convenience, quickness and automation aptitude, and has problems in that the tools and devices to be used in this method are not suited for automation and miniaturization, it is difficult to produce the tools and devices, particularly an adsorption medium, in an industrially large scale with the same performance, and their handling is so inconvenient that they are difficult to be processed in various shapes.

Also, as one of the methods for separating and purifying nucleic acid conveniently and efficiently, a method has been proposed in which nucleic acid is separated and purified by adsorbing nucleic acid to and desorbing nucleic acid from a solid phase comprising an organic polymer having hydroxyl group on the surface in which the adsorbing and the desorbing each uses a solution for adsorbing nucleic acid to the solid phase and a solution for desorbing nucleic acid from the solid phase, respectively (e.g., JP-A-2003-128691 and JP-A-2004-49108).

Examples of other related methods for separating and purifying nucleic acid include those which use centrifugation, magnetic beads or porous membrane. In addition, devices for separating and purifying nucleic acid which use these methods have been proposed. For example, as a device for separating and purifying nucleic acid making use of a porous membrane, an automatic device has been proposed in which a large number of porous membranes are set on a rack, a sample solution containing nucleic acid is dispensed into them, periphery of the bottom part of the aforementioned rack is tightly shut with an air chamber via a sealing material to reduce the inside pressure, all of the porous membrane tubes are simultaneously vacuumed from the discharging side to allow the sample solution to pass through them and to effect adsorption of nucleic acid to the porous membranes, and subsequently, a washing solution and a recovering solution are dispensed and vacuumed under a reduced pressure is again carried out to effect the washing and desorption (e.g., Japanese Patent No. 2,832,586).

### DISCLOSURE OF THE INVENTION

However, the related nucleic acid separation methods are not sufficient yet in terms of the yield and purity, so that further improvement is required. Particularly, the nucleic acid separation method which uses porous membrane has problems in that definition of the porous membrane is ambiguous, and yield and purity of recovered nucleic acid are unstable among kinds and lots of the porous membrane.

Accordingly, the object of the invention is to provide a method for separating and purifying nucleic acid, by which stable amount and purity of nucleic acid can be recovered conveniently and easily.

With the aim of solving the aforementioned problems, the present inventors have conducted intensive examinations and found as a result that nucleic acid having high purity can be separated in a stable amount from an analyte containing nucleic acid in a method for separating and purifying nucleic acid, which comprises the steps of adsorbing and desorbing nucleic acid to and from a porous membrane, by defining a physical property of the surface of a nucleic acid adsorbing porous membrane, namely contact angle when water is dropped, and using a cartridge for separation and purification of nucleic acid prepared by receiving the nucleic acid adsorbing porous membrane in a container having two openings. The invention has been accomplished based on these findings. That is, the invention comprised of the following constructions.

(1) A method for separating and purifying a nucleic acid, which comprises:

<1> adsorbing the nucleic acid to a nucleic acid adsorbing porous membrane by passing a sample solution containing the nucleic acid through the nucleic acid adsorbing porous membrane;

<2> washing the nucleic acid adsorbing porous membrane by passing a washing solution through the nucleic acid adsorbing porous membrane, while the nucleic acid is adsorbed to the nucleic acid adsorbing porous membrane; and

<3> desorbing the nucleic acid from the nucleic acid adsorbing porous membrane by passing a recovering solution through the nucleic acid adsorbing porous membrane,

wherein the nucleic acid adsorbing porous membrane is a porous membrane that has a contact angle of 60° or less after 17 m seconds of contact of the porous membrane with 3 μl of water dropped to the porous membrane.

(2) The method for separating and purifying a nucleic acid as described in (1) above,

wherein the porous membrane has a contact angle of 50° or less.

(3) The method for separating and purifying a nucleic acid as described in (1) or (2) above,

wherein the nucleic acid adsorbing porous membrane is a porous membrane comprising an organic polymer to which the nucleic acid is adsorbed by a weak interaction involving substantially no ionic bond.

(4) The method for separating and purifying a nucleic acid as described in any of (1) to (3) above,

wherein the nucleic acid adsorbing porous membrane is a porous membrane comprising an organic polymer having a hydroxyl group.

(5) The method for separating and purifying a nucleic acid as described in any of (1) to (4) above,

wherein the nucleic acid adsorbing porous membrane is a porous membrane obtained by saponification of a mixture of acetyl celluloses different from each other in acetyl value.

(6) The method for separating and purifying a nucleic acid as described in any of (1) to (5) above,

wherein the nucleic acid adsorbing porous membrane has a front surface and a back surface asymmetrical with each other.

(7) The method for separating and purifying a nucleic acid as described in (6) above,

the nucleic acid adsorbing porous membrane has a larger average pore size on the front surface than an average pore size on the back surface.

(8) The method for separating and purifying a nucleic acid as described in any of (1) to (7) above,

wherein the sample solution containing a nucleic acid is a solution where a water-soluble organic solvent is added to a solution obtained by treating a cell or virus-containing analyte with a nucleic acid solubilizing reagent.

(9) The method for separating and purifying a nucleic acid as described in (8) above,

wherein the nucleic acid solubilizing reagent is a solution containing at least one of a chaotropic salt, a surface active agent, a proteolytic enzyme, an antifoaming agent and a reducing agent.

(10) The method for separating and purifying a nucleic acid as described in (8) or (9) above,

wherein the water-soluble organic solvent is at least one alcohol selected from methanol, ethanol, propanol and an isomer thereof, and butanol and an isomer thereof.

(11) The method for separating and purifying a nucleic acid as described in any of (1) to (10) above,

wherein the washing solution is a solution containing at least one of methanol, ethanol, propanol and an isomer thereof, and butanol and an isomer thereof in a total amount of 20 to 100% by weight.

(12) The method for separating and purifying a nucleic acid as described in any of (1) to (11) above,

wherein the recovering solution is a solution having a salt concentration of 0.5 M or less.

(13) The method for separating and purifying a nucleic acid as described in any of (1) to (12) above, which uses a cartridge for separation and purification of nucleic acid,

wherein the cartridge for separation and purification of nucleic acid comprises:

a container having at least two openings; and

a nucleic acid adsorbing porous membrane being received in the container.

(14) The method for separating and purifying a nucleic acid as described in any of (1) to (13) above,

wherein the sample solution containing a nucleic acid, the washing solution or the recovering solution is passed through the nucleic acid adsorbing porous membrane by using a pressure difference producing device.

(15) A device for carrying out a method for separating and purifying a nucleic acid as described in any of (1) to (14) above.

(16) A reagent kit for carrying out a method for separating and purifying a nucleic acid as described in any of (1) to (14) above.

### BEST MODE FOR CARRYING OUT THE INVENTION

The nucleic acid separation and purification method of the invention comprises at least (1) a step in which a sample solution containing a nucleic acid is passed through a nucleic acid adsorbing porous membrane to effect adsorption of the nucleic acid, (2) a step in which said nucleic acid adsorbing porous membrane is washed while the nucleic acid is adsorbed, and (3) a step in which a recovering solution is passed through said nucleic acid adsorbing porous membrane to effect desorption of the nucleic acid from inside of said porous membrane.

Preferably, the sample solution containing nucleic acid, washing solution or recovering solution is passed through a nucleic acid adsorbing porous membrane under a compressed condition in each step of the aforementioned (1), (2) and (3), and more preferably, the sample solution containing nucleic acid, washing solution or recovering solution is injected into one opening of cartridge for separation and purification of nucleic acid prepared by containing a nucleic acid adsorbing porous membrane in a container having at least two openings, and each of said injected solutions is passed through by using a pressure difference producing device connected to the aforementioned one opening of the cartridge and discharged from the other opening. By passing the sample solution containing nucleic acid, washing solution or recovering solution through the aforementioned porous membrane, the device can be compactly automated, which is desirable. Pressurization of the pump carried out preferably at from 10 to 300 kPa, more preferably from 40 to 200 kPa.

In addition, preferably, nucleic acid can be separated and purified by the following steps. That is,
(a) a step in which a sample solution containing nucleic acid is injected into one opening of a cartridge for separation and purification of nucleic acid prepared by receiving a nucleic acid adsorbing porous membrane in a container having at least two openings, through which the solution can pass,
(b) a step in which inside of the cartridge for separation and purification of nucleic acid is made into a pressurized state using a pressure difference producing device connected to the aforementioned one opening of the cartridge for separation and purification of nucleic acid, and the injected sample solution containing nucleic acid is passed through the nucleic acid adsorbing porous membrane and discharged from the other opening of the cartridge for separation and purification of nucleic acid, thereby effecting adsorption of nucleic acid to inside of the nucleic acid adsorbing porous membrane,
(c) a step in which a washing solution is injected into the aforementioned one opening of the cartridge for separation and purification of nucleic acid,
(d) a step in which inside of the cartridge for separation and purification of nucleic acid is made into a pressurized state using a pressure difference producing device connected to the aforementioned one opening of the cartridge for separation and purification of nucleic acid, and the injected washing solution is passed through the nucleic acid adsorbing porous membrane and discharged from the other opening, thereby effecting washing of the nucleic acid adsorbing porous membrane while nucleic acid is adsorbed,
(e) a step in which a recovering solution is injected into the aforementioned one opening of the cartridge for separation and purification of nucleic acid,
(f) a step in which inside of the cartridge for separation and purification of nucleic acid is made into a pressurized state using a pressure difference producing device connected to the aforementioned one opening of the cartridge for separation and purification of nucleic acid, and the injected recovering solution is passed through the nucleic acid adsorbing porous membrane and discharged from the other opening, thereby effecting desorption of nucleic acid from inside of the nucleic acid adsorbing porous membrane and discharging desorption nucleic acid to the outside of the cartridge for separation and purification of nucleic acid can be exemplified.

According to the aforementioned nucleic acid separation purification steps, it is possible to complete the steps of from firstly injecting a sample solution containing nucleic acid until obtaining nucleic acid in the outside of the cartridge for separation and purification of nucleic acid within 20 minutes, or within 2 minutes under suitable conditions.

Also, a nucleic acid having a broad range molecular weight of from 1 kbp to 200 kbp, particularly from 20 kbp to 140 kbp can be recovered by the aforementioned nucleic acid separation purification steps. That is, a long chain nucleic acid can be recovered in comparison with the related used glass filter-aided spin column method (Qiagen).

Also, by the aforementioned nucleic acid separation purification steps, nucleic acid having a purity of from 1.6 to 2.0 in the case of DNA or from 1.8 to 2.2 in the case of RNA, as measured value (260 nm/280 nm) by a spectrophotometer for ultraviolet and visible region, can be recovered, so that high purity nucleic acid having less contaminants can be constantly obtained. In addition, nucleic acid having a purity of around 1.8 in the case of DNA or around 2.0 in the case of RNA, as measured value (260 nm/280 nm) by a spectrophotometer for ultraviolet and visible region, can be recovered.

Also, examples of the pressure difference producing device to be used in the aforementioned steps include an injector, a Pipetter, or a Peristaltic pump or the like pump that can effect pressurization, or a evaporator or the like that can effect depressurization. Among these, an injector is suited for manual operation, and a pump for automatic operation. In addition, a Pipetter has an advantage in that one hand operation can be easily carried out. Preferably, the pressure difference producing device is connected to the one opening of the cartridge for separation and purification of nucleic acid in such a manner that it can be detached.

In addition, the aforementioned steps can also be carried out by making inside of the cartridge for separation and purification of nucleic acid into a depressurized state using a pressure difference producing device connected to the other opening of the aforementioned cartridge for separation and purification of nucleic acid. As other method, it can be suitably carried out by applying a centrifugal force to the cartridge for separation and purification of nucleic acid.

Though the analyte which can be used in the invention is not limited, for example in the case of the field of diagnosis, its examples include whole blood, plasma, serum, urine, feces, semen, saliva and the like body fluids collected as the analytes, or solutions prepared from a plant (or a part thereof), an animal (or a part thereof), a bacterium, a virus and the like, or lysates or homogenates thereof, and the like biological materials.

These analytes are generally treated with an aqueous solution containing a reagent capable of dissolving cell membrane and nuclear membrane and thereby solubilizing nucleic acid (nucleic acid solubilizing reagent). By this treatment, cell membrane and nuclear membrane are dissolved and nucleic acid is dispersed in the aqueous solution so that a sample solution containing nucleic acid is obtained.

In order to effect solubilization of nucleic acid by dissolving cell membrane and nuclear membrane, for example, when the analyte is whole blood, (A) elimination of erythrocytes, (B) elimination of various proteins and (C) dissolution of leukocytes and dissolution of nuclear membrane are necessary. It is desirable to carry out the (A) elimination of erythrocytes and (B) elimination of various proteins in order to prevent their nonspecific adhesion to the membrane and clogging of the porous membrane, and the (C) dissolution of leukocytes and dissolution of nuclear membrane in order to effect solubilization of nucleic acid as the object of extraction. According to the method of the invention, it is necessary in general to effect solubilization of nucleic acid by this process.

The analyte containing nucleic acid may be either an analyte containing a single nucleic acid or an analyte containing two or more different nucleic acids. Kinds of the nucleic acid to be recovered are DNA, RNA and the like and not particularly limited. The number of analytes may be one or two or more (parallel treatment of two or more analytes using two or more containers). Length of the nucleic acid to be recovered is not particularly limited, too. And a nucleic acid having an optional length of, for example, from several bp to several Mbp can be used. From the viewpoint of handling, the length of the nucleic acid to be recovered is generally from about several bp to several hundreds kbp. The nucleic acid separation purification method of the invention can quickly extract relatively longer nucleic acid than the related simple nucleic acid separation purification method, and can recover a nucleic acid of preferably 50 kbp or more, more preferably 70 kbp or more and further preferably 100 kbp or more.

The steps for obtaining a sample solution containing nucleic acid from an analyte by dissolving cell membrane and nuclear membrane are described in the following.

They are characterized by including the following steps:
(a) a step for injecting an analyte containing a cell or virus into a container;
(b) a step for mixing the analyte by adding a pretreatment solution containing a chaotropic salt, a surface active agent and a nucleic acid stabilizing agent to the aforementioned container; and
(c) a step for adding a water-soluble organic solvent to the mixed solution obtained in the above.

A nucleic acid solubilizing reagent is used for solubilizing nucleic acid by dissolving cell membrane. As the nucleic acid solubilizing reagent, a solution containing a chaotropic salt, a surface active agent, a proteolytic enzyme, an antifoaming agent and/or a nucleic acid stabilizing agent can be exemplified.

Concentration of the chaotropic salt in the aforementioned nucleic acid solubilizing reagent is preferably 0.5 M or more, more preferably from 0.5 M to 4 M, further preferably from 1 M to 3 M. As the aforementioned chaotropic salt, guanidine hydrochloride is desirable, but other chaotropic salt (guanidine isothiocyanate or guanidine thiocyanate) can also be used. In addition, these salts may be used alone or in combination of two or more.

The surface active agent in the aforementioned nucleic acid solubilizing reagent is, for example, a nonionic surface active agent, a cationic surface active agent, an anionic surface active agent or an ampholytic surface active agent.

A nonionic surface active agent can be preferably used in the invention. As the nonionic surface active agent, a polyoxyethylene alkylphenyl ether surface active agent, polyoxyethylene alkyl ether surface active agent or a fatty acid alkanoyl amide can be used, but preferably a polyoxyethylene alkyl ether surface active agent can be used, and further preferably, the a polyoxyethylene alkyl ether surface active agent is a polyoxyethylene alkyl ether surface active agent selected from POE decyl ether, POE lauryl ether, POE tridecyl ether, POE alkylene decyl ether, POE sorbitan monolaurate, POE sorbitan monooleate, POE sorbitan monostearate, polyoxyethylene sorbitan tetraoleate, POE alkylamine and POE acetylene glycol.

In addition, a cationic surface active agent can also be preferably used. Further preferably, the cationic surface active agent is a cationic surface active agent selected from cetyltrimethylammonium bromide, dodecyltrimethylammonium chloride, tetradecyltrimethylammonium chloride and cetylpyridinium chloride. These surface active agents may be used alone or as a combination of two or more. Concentration of these surface active agent in the nucleic acid solubilizing reagent solution is preferably from 0.1 to 20% by weight.

In addition, by containing a proteolytic enzyme in the nucleic acid solubilizing reagent, recovered amount and recovery efficiency of nucleic acid are improved and micro-quantity of the analyte containing a necessary nucleic acid and quickening become possible.

As the proteolytic enzyme, at least one proteolytic enzyme selected from a serine protease, a cysteine protease, a metalloprotease and the like can be preferably used. In addition, a mixture of two or more proteolytic enzymes can also be used preferably as the proteolytic enzyme.

The serine protease is not particularly limited, and protease K or the like can for example be used preferably. The cysteine protease is not particularly limited, and papain, cathepsin or the like can for example be used preferably. The metalloprotease is not particularly limited, and carboxypeptidase or the like can for example be used preferably.

The proteolytic enzyme can be used at a concentration of preferably from 0.001 IU to 10 IU, more preferably from 0.01 IU to 1 IU, per 1 ml total volume of the reaction system at the time of its addition.

In addition, a proteolytic enzyme which does not contain nuclease can be preferably used as the proteolytic enzyme. Also, a proteolytic enzyme containing a stabilizing agent can be used preferably. As the stabilizing agent, a metal ion can be used preferably. Illustratively, magnesium ion is desirable, and for example, it can be added in the form of magnesium chloride or the like. By containing a stabilizing agent for a proteolytic enzyme, micro-quantity of the proteolytic enzyme necessary for the recovery of nucleic acid becomes possible and the cost necessary for the recovery of nucleic acid can be reduced. It is desirable that the stabilizing agent for the proteolytic enzyme is contained at a concentration of preferably from 1 to 1000 mM, more preferably from 10 to 100 mM, based on the total volume of the reaction system.

The proteolytic enzyme may be used in the recovery of nucleic acid as one reagent by mixing with a chaotropic salt, a surface active agent and the like other reagents in advance.

In addition, the proteolytic enzyme may be used as two or more reagents separately from a chaotropic salt, a surface active agent and the like other reagents. In the latter case, a reagent containing the proteolytic enzyme is firstly mixed with an analyte and then mixed with a reagent containing a chaotropic salt and a surface active agent. Alternatively, the proteolytic enzyme may be mixed after firstly mixing a reagent containing a chaotropic salt and a surface active agent.

In addition, the proteolytic enzyme can be added dropwise to an analyte, or a mixture of the analyte with a reagent containing a chaotropic salt and a surface active agent, directly in an eyewash shape from a proteolytic enzyme preserving container. In that case, the operation can be simplified.

It is also desirable that the nucleic acid solubilizing reagent is used in a dried state. Also, a container containing dried proteolytic enzyme like the case of freeze-drying in advance can be used. A sample solution containing nucleic acid can also be obtained by using both of the aforementioned containers containing nucleic acid solubilizing reagent to be used in the dried state and the proteolytic enzyme of the dried state in advance.

When a sample solution containing nucleic acid is obtained by the above method, storage stability of the nucleic acid solubilizing reagent and proteolytic enzyme are good so that the operation can be simplified without altering the nucleic acid yield.

It is more desirable that a nucleic acid stabilizing agent is allowed to coexist in the nucleic acid solubilizing reagent. Since nuclease or the like substance which degrades nucleic acid is sometimes contained in analytes, when nucleic acid is homogenized, this nuclease acts upon nucleic acid so that the yield is sharply reduced in such a case. In order to avoid this, a stabilizing agent can be coexisted in the nucleic acid solubilizing reagent. Since the stabilizing agent has an action to inactivate nuclease activity, this agent is used for the purpose of allowing the nucleic acid in analytes to be stably present based on this action. By this action, recovered amount and recovery efficiency of nucleic acid are improved and micro-quantity of the analyte and quickening become possible.

As the nuclease inactivation agent, generally a reducing agent can be preferably used. Examples of the reducing agent include hydrogen, hydrogen iodide, hydrogen sulfide, lithium aluminum hydride, sodium borohydride and the like hydride compounds, an alkali metal, magnesium, calcium, aluminum, zinc and the like metals having large electrical positive, or amalgam thereof, aldehydes, saccharides, formic acid, oxalic acid and the like organic oxides, and the like, but a mercapto compound is desirable. Examples of the mercapto compound include N-acetylcysteine, mercaptoethanol, alkyl mercaptan and the like, though not particularly limited thereto. The mercapto compound can be used as a pretreatment solution at a weight concentration of from 0.1 to 20%, more preferably from 0.5 to 15%.

It is also desirable to contain an antifoaming agent in the aforementioned nucleic acid solubilizing reagent. As the aforementioned antifoaming agent, two components of a silicon antifoaming agent and an alcohol antifoaming agent can be preferably exemplified, and an acetylene glycol surface active agent is desirable as the alcohol antifoaming agent.

Illustrative examples of the antifoaming agent include a silicon antifoaming agent (e.g., silicon oil, dimethylpolysiloxane, silicone emulsion, modified polysiloxane, silicone compound or the like), a alcohol antifoaming agent (e.g., acetylene glycol, heptanol, ethylhexanol, higher alcohol, polyoxyalkylene glycol or the like), an ether antifoaming agent (e.g., heptyl cellosolve, nonyl cellosolve-3-heptylsorbitol or the like), an oils and fats antifoaming agent (e.g., an animal or plant oil or the like), a fatty acid antifoaming agent (e.g., stearic acid, oleic acid, palmitic acid or the like), a metallic soap antifoaming agent (e.g., aluminum stearate, calcium stearate or the like), a fatty acid ester antifoaming agent (e.g., natural wax, tributyl phosphate or the like), a phosphoric acid ester antifoaming agent (e.g., sodium octylphosphate or the like), an amine antifoaming agent (e.g., diamylamine or the like), an amide antifoaming agent (e.g., stearic acid amide or the like), other antifoaming agent (e.g., ferric sulfate, bauxite or the like) and the like. Particularly preferably, two components of a silicon antifoaming agent and an alcohol antifoaming agent can be combined and used as an antifoaming agent. In addition, the use of an acetylene glycol surface active agent as the alcohol antifoaming agent is also desirable.

In addition, the aforementioned nucleic acid solubilizing reagent may also contain a water-soluble organic solvent. This water-soluble organic solvent is used for the purpose of increasing solubility of respective reagents contained in the nucleic acid solubilizing reagent, and its examples include acetone, chloroform, dimethylformamide and the like, but an alcohol is desirable. The alcohol may be any one of primary alcohols, secondary alcohols and tertiary alcohols. An alcohol selected from methyl alcohol, ethyl alcohol, propyl alcohol and isomers thereof, and butyl alcohol and isomers thereof can be used more preferably. These water-soluble organic solvents may be used alone or as a combination of two or more. It is desirable that the concentration of these water-soluble organic solvents in the nucleic acid solubilizing reagent is from 1 to 20% by weight.

The aforementioned nucleic acid solubilizing reagent solution preferably has a pH value of from 5 to 10, more preferably a pH value of from 6 to 9, further preferably a pH value of from 7 to 8.

The following describes the step in which a sample solution containing nucleic acid is obtained from an analyte by dissolving cell membrane and nuclear membrane and thereby solubilizing nucleic acid. Regarding the step in which a sample solution containing nucleic acid is obtained from an analyte by dissolving cell membrane and nuclear membrane and thereby solubilizing nucleic acid, its automatic treatment aptitude is improved when the analyte is subjected to a homogenization treatment. The homogenization treatment can be carried out, for example, by employing an ultrasonic treatment, using a sharp projection, using a high speed agitation treatment, by an extrusion treatment from a fine void, a treatment using glass beads or the like.

The method for mixing the homogenized analyte with the nucleic acid solubilizing reagent containing a chaotropic salt, a surface active agent, an antifoaming agent and/or a nucleic acid stabilizing agent is not particularly limited. In carrying out the mixing, it is desirable to mix at from 30 to 3,000 rpm for 1 second to 3 minutes using a mixing device. By this mixing, yield of the separated and purified nucleic acid can be increased. Alternatively, it is also desirable to mix them by carrying out inverting the tube from 5 to 30 times. In addition, the mixing can also be effected by carrying out a pipette operation from 10 to 50 times, and in that case, yield of the separated and purified nucleic acid can be increased by a convenient operation.

Regarding the step in which a sample solution containing nucleic acid is obtained from an analyte by dissolving cell membrane and nuclear membrane and thereby solubilizing nucleic acid, it is desirable to subsequently add a water-soluble organic solvent to the aforementioned mixed solution. An alcohol can be preferably used as the water-soluble organic solvent to be added to the mixed solution. The alcohol may be any one of primary alcohols, secondary alcohols and tertiary alcohols, and an alcohol selected from methyl alcohol, ethyl alcohol, propyl alcohol, butyl alcohol and isomers thereof can be preferably used. It is desirable that the final concentration of these water-soluble organic solvents in a sample solution containing nucleic acid is from 5 to 90% by weight.

In addition, it is desirable that the thus obtained sample solution containing nucleic acid has a surface tension of 0.05 J/m² or less, a viscosity of from 1 to 10,000 mPa and a specific gravity of from 0.8 to 1.2. By adjusting the solution to such physical properties, the sample solution can be easily removed after contact of the sample solution with the nucleic acid adsorbing porous membrane in the next step.

The nucleic acid adsorbing porous membrane to be used in the invention and the adsorption step are described in the following.

The nucleic acid adsorbing porous membrane of the invention is a membrane through which a solution can pass. The term “through which a solution can pass” as used herein means that, when a pressure difference is formed between a space contacting with one surface of the membrane and a space contacting with the other surface of the membrane, a solution can pass through the inside of the membrane from the high pressure space side to the low pressure side. Alternatively, it means that when a centrifugal force is applied to the membrane, the solution can pass through the inside of the membrane in the direction of the centrifugal force.

The nucleic acid adsorbing porous membrane of the invention is markedly characterized in that surface contact angle just after dropping of water to said porous membrane is 60° or less. As a result of various examinations, the present inventors have found that hydrophilic property of the surface of porous membrane greatly exert influence upon the separation performance of nucleic acid, and that the value of contact angle of the porous membrane to be used with respect to water, as a value which quantitatively defines this phenomenon, is effective as an index of the porous membrane. That is, according to the invention, it was found that the separation purification performance of nucleic acid is sharply improved when 3 μl of water is dropped to each of porous membrane samples to measure contact angle 17 m seconds after contact of the droplet to the membrane, and a porous membrane showing a value of 60° or less is used. More preferably, a porous membrane having a contact angle of 50° or less is used.

In general, wettability to water is evaluated as a means for evaluating hydrophilic property of a substance. As a means for quantitatively evaluating the water wettability, a contact angle between water and a substance when a droplet is dropped to the substance is most convenient and can be calculated accurately. In general, the contact angle becomes small and limitlessly approaches 0° when the hydrophilic property is high, and when the hydrophilic property is low, the contact angle becomes large and approaches 180°. However, when the substance is a porous membrane, droplets are soaked into the membrane due to capillary phenomenon. Accordingly, a countermeasure was found that the contact angle just after contact is measured, namely, the angle is measured at a relatively short period of time of 17 m seconds after contact with the porous membrane, and the value is used as a parameter of the hydrophilic property.

Examples of the method for adjusting the aforementioned surface contact angle of a porous membrane to 60° or less, preferably 50° or less include a method in which the number of OH group is increased by carrying out an acid or alkali hydrolysis and a method in which OH groups are added using a special device for glow discharge, ozone treatment or the like.

It is desirable that the nucleic acid adsorbing porous membrane is a porous membrane to which nucleic acid is adsorbed by an interaction wherein ionic bond is not substantially concerned. This means that “ionization” is not occurred under the condition for the porous membrane use, and it is considered that the nucleic acid and porous membrane attract each other by changing polarity of the environment. By this, nucleic acid can be isolated and purified with superior separation performance and good washing efficiency. In order to increase affinity of the nucleic acid and porous membrane more efficiently, it is desirable that the porous membrane has a hydrophilic group, and the increase of peak strength of the invention means increase of the number of hydrophilic groups of the porous membrane. The force of hydrophilic groups of nucleic acid and porous membrane to attract each other can be adjusted by changing polarity of the environment in a porous membrane having a large numbers of hydrophilic groups.

The hydrophilic group is polar group (atomic group) which can have interaction with water, and all of the groups (atomic groups) concerned in the adsorption of nucleic acid come under this. As the hydrophilic group, a group having a medium degree of strength of its interaction with water (cf. “a group of not so strong hydrophilic property” in the item “hydrophilic group” in ENCYCLOPAEDIA CHIMICA, published by Kyoritsu Shuppan) is suitable, and its examples include hydroxyl group, carboxyl group, cyano group, oxyethylene group and the like. Preferred is hydroxyl group in achieving the surface contact angle of the invention.

In this connection, the porous membrane having a hydrophilic group means a porous membrane in which the porous membrane-material by itself has a hydrophilic group, or a porous membrane into which a hydrophilic group is introduced by treating or coating a material which forms the porous membrane. The porous membrane-forming material may be either an organic substance or an inorganic substance. For example, a porous membrane in which its porous membrane-forming material itself is an organic material having a hydrophilic group, a porous membrane into which a hydrophilic group is introduced by treating a porous membrane of organic material having no hydrophilic group, a porous membrane into which a hydrophilic group is introduced by coating a porous membrane of organic material having no hydrophilic group with a material having a hydrophilic group, a porous membrane in which its porous membrane-forming material itself is an inorganic material having a hydrophilic group, a porous membrane into which a hydrophilic group is introduced by treating a porous membrane of inorganic material having no hydrophilic group, a porous membrane into which a hydrophilic group is introduced by coating a porous membrane of organic material having no hydrophilic group with a material having a hydrophilic group, and the like can be used, but from the viewpoint of easy processing, it is desirable to use an organic polymer or the like organic material as the porous membrane-forming material.

As the porous membrane of an organic material having a hydrophilic group, a porous membrane of an organic material having hydroxyl group can be cited. As the porous membrane of an organic material having a hydrophilic group, a porous membrane formed from polyhydroxyethyl acrylate, polyhydroxyethyl methacrylate, polyvinyl alcohol, acetyl cellulose, a mixture of acetyl celluloses having different acetyl values or the like can be exemplified. Particularly, a porous membrane of an organic material having a polysaccharide structure can be used preferably.

As the porous membrane of an organic material having hydroxyl group, a porous membrane of an organic polymer consisting of a mixture of acetyl celluloses having different acetyl values can be preferably used. As the mixture of acetyl celluloses having different acetyl values, a mixture of triacetyl cellulose and diacetyl cellulose, a mixture of triacetyl cellulose and monoacetyl cellulose, a mixture of triacetyl cellulose, diacetyl cellulose and monoacetyl cellulose and a mixture of diacetyl cellulose and monoacetyl cellulose can be suitably used. Particularly, a mixture of triacetyl cellulose and diacetyl cellulose can be suitably used. Mixing ratio (weight ratio) of triacetyl cellulose and diacetyl cellulose is preferably from 99:1 to 1:99, more preferably from 90:10 to 50:50.

As a further desirable organic material having hydroxyl group, the surface saponification products of acetyl cellulose described in JP-A-2003-128691 can be exemplified. The surface saponification products of acetyl cellulose are products in which a mixture of acetyl celluloses having different acetyl values is saponification-treated, and a saponification product of a mixture of triacetyl cellulose and diacetyl cellulose, a saponification product of a mixture of triacetyl cellulose and monoacetyl cellulose, a saponification product of a mixture of triacetyl cellulose, diacetyl cellulose and monoacetyl cellulose and a saponification product of a mixture of diacetyl cellulose and monoacetyl cellulose can be suitably used. Particularly, a saponification product of a mixture of triacetyl cellulose and diacetyl cellulose can be used more suitably. Mixing ratio (weight ratio) of a mixture of triacetyl cellulose and diacetyl cellulose is preferably from 99:1 to 1:99. More preferably, mixing ratio of a mixture of triacetyl cellulose and diacetyl cellulose is from 90:10 to 50:50. In this case, the amount (density) of hydroxyl group on the solid phase surface can be controlled by the degree of saponification treatment (saponification ratio). In order to improve separation efficiency of nucleic acid, it is desirable that the amount (density) of hydroxyl group is large. Saponification ratio (surface saponification ratio) of the organic material obtained by the saponification treatment is preferably about 5% or more and 100% or less, more preferably 10% or more and 100% or less. In addition, in order to increase surface area of the organic material having hydroxyl group, it is desirable to carry out saponification treatment of the porous membrane of acetyl cellulose. The porous membrane may be a porous membrane having a front surface and a back surface symmetrical with each other, but a porous membrane having a front surface and a back surface asymmetrical with each other can be suitably used. The term “having a front surface and a back surface asymmetrical with each other” as used herein means that physical and/or chemical properties of the membrane change from one surface of the porous membrane to the other surface thereof. An example of the physical properties is an average pore size. In the invention, a porous membrane having a larger average pore size on the front surface than an average pore size on the back surface is preferably used, and it is preferable that solutions pass through from the front surface to the back surface.

In this connection, the saponification treatment means that acetyl cellulose is allowed to contact with a saponification treatment solution (e.g., sodium hydroxide aqueous solution). By this, a part of acetyl cellulose contacted with the saponification treatment solution becomes a regenerated cellulose so that hydroxyl group is introduced. The regenerated cellulose prepared in this manner is different from the original cellulose in terms of crystalline state and the like. According to the invention, it is particularly desirable to use a porous membrane of regenerated cellulose as the porous membrane.

In addition, for changing the saponification ratio, the saponification treatment may be carried out by changing concentration of sodium hydroxide.

Regarding the method for introducing hydrophilic group into a porous membrane of an organic material having no hydrophilic group, a graft polymer chain having a hydrophilic group inside of the polymer chain or its side chain can be linked to the porous membrane.

Regarding the method for linking a graft polymer chain to a porous membrane of an organic material, there are a method in which the porous membrane and graft polymer chain are chemically bonded and a method in which a compound having a polymerizable double bond is made into a graft polymer chain by polymerizing it using the porous membrane as the starting point.

Firstly, in the method in which the porous membrane and graft polymer chain are chemically bonded, a polymer having a functional group capable of reacting with the porous membrane in the terminus or side chain of the polymer is used, and they are grafted through a chemical reaction of this functional group with a functional group of the porous membrane. The functional group capable of reacting with the porous membrane is not particularly limited with the proviso that it can react with a functional group of the porous membrane, and its examples include a silane coupling group such as alkoxysilane, isocyanate group, amino group, hydroxyl group, carboxyl group, sulfonate group, phosphate group, epoxy group, allyl group, methacryloyl group, acryloyl group and the like.

Examples of the compound particularly useful as the polymer having a reactive functional group in the terminus or side chain of the polymer include a polymer having trialkoxysilyl group in the polymer terminus, a polymer having amino group in the polymer terminus, a polymer having carboxyl group in the polymer terminus, a polymer having epoxy group in the polymer terminus and a polymer having isocyanate group in the polymer terminus. The polymer to be used in this case is not particularly limited with the proviso that it has a hydrophilic group which is concerned in the adsorption of nucleic acid, and its illustrative examples include polyhydroxyethyl acrylic acid, polyhydroxyethyl methacrylic acid and salts thereof, polyvinyl alcohol, polyvinyl pyrrolidone, polyacrylic acid, polymethacrylic acid and salts thereof, polyoxyethylene and the like.

The method in which a compound having a polymerizable double bond is made into a graft polymer chain by polymerizing it using the porous membrane as the starting point is generally called surface graft polymerization. The surface graft polymerization method means a method in which an active species is provided on the base material surface by plasma irradiation, light irradiation, heating or the like method, and a polymerizable compound having double bond arranged in contact with a porous membrane is linked to the porous membrane by polymerization.

It is necessary that the compound useful for forming a graft polymer chain linked to the base material has both of two characteristics of having a polymerizable double bond and having a hydrophilic group which is concerned in the adsorption of nucleic acid. As such a compound, any one of the polymers, oligomers and monomers having a hydrophilic group can be used with the proviso that it has a double bond in the molecule. Particularly useful compound is a monomer having a hydrophilic group.

As illustrative examples of the particularly useful monomer having a hydrophilic group, the following monomers can be cited. For example, 2-hydroxyethyl acrylate, 2-hydroxyethyl methacrylate, glycerol monomethacrylate and the like hydroxyl group-containing monomers can be used particularly suitably. In addition, acrylic acid, methacrylic acid and the like carboxyl group-containing monomers or alkali metal salts and amine salts thereof can also be used suitably.

As another method for introducing a hydrophilic group into a porous membrane of an organic material having no hydrophilic group, a material having a hydrophilic group can be coated. The material to be used in the coating is not particularly limited with the proviso that it has a hydrophilic group which is concerned in the adsorption of nucleic acid, but is preferably a polymer of an organic material from the viewpoint of easy handling. Examples of the polymer include polyhydroxyethyl acrylate, polyhydroxyethyl methacrylate and salts thereof, polyvinyl alcohol, polyvinyl pyrrolidone, polyacrylic acid, polymethacrylic acid and salts thereof, polyoxyethylene, acetyl cellulose, a mixture of acetyl celluloses having different acetyl values and the like, but a polymer having a polysaccharide structure is desirable.

Alternatively, it is possible to coat acetyl cellulose or a mixture of acetyl celluloses having different acetyl values on a porous membrane of an organic material having no hydrophilic group and then to subject the coated acetyl cellulose or a mixture of acetyl celluloses having different acetyl values to a saponification treatment. In that case, the saponification ratio is preferably about 5% or more and 100% or less. The saponification ratio is more preferably 10% or more and 100% or less.

As the porous membrane of an inorganic material having a hydrophilic group, a porous membrane containing a silica compound can be exemplified. As the porous membrane containing a silica compound, a glass filter can be exemplified. Also can be exemplified is a porous silica thin membrane described in Japanese Patent No. 3,058,3442. This porous silica thin membrane can be prepared by spreading a developing solution of a cationic amphipathic substance having an ability to form a bimolecular membrane on a base material, preparing multi-layered bimolecular thin membranes of the amphipathic substance by removing the solvent from the liquid membrane on the base material, allowing the multi-layered bimolecular thin membranes to contact with a solution containing a silica compound, and then extracting and removing the aforementioned multi-layered bimolecular thin membranes.

Regarding the method for introducing a hydrophilic group into a porous membrane of an inorganic material having no hydrophilic group, there are a method in which the porous membrane and a graft polymer chain are chemically bonded and a method in which a graft polymer chain is polymerized using a hydrophilic group-containing monomer having a double bond in the molecule, using the porous membrane as the starting point.

When the porous membrane and graft polymer chain are attached by chemical bonding, a functional group capable of reacting with a terminal functional group of the graft polymer chain is introduced into an inorganic material, and the graft polymer chain is chemically bonded thereto. Also, when a graft polymer chain is polymerized using a hydrophilic group-containing monomer having a double bond in the molecule and using the porous membrane as the starting point, a functional group which becomes the starting point in polymerizing the double bond-containing compound is inserted into the inorganic material.

As the graft polymer having a hydrophilic group and hydrophilic group-containing monomer having a double bond in the molecule, the aforementioned graft polymer having a hydrophilic group and hydrophilic group-containing monomer having a double bond in the molecule, described in the foregoing regarding the method for introducing a hydrophilic group into a porous membrane of an organic material having no hydrophilic group, can be suitably use.

As another method for introducing a hydrophilic group into a porous membrane of an inorganic material having no hydrophilic group, a material having a hydrophilic group can be coated. The material to be used in the coating is not particularly limited with the proviso that it has a hydrophilic group which is concerned in the adsorption of nucleic acid, but is preferably a polymer of an organic material from the viewpoint of easy handling. Examples of the polymer include polyhydroxyethyl acrylate, polyhydroxyethyl methacrylate and salts thereof, polyvinyl alcohol, polyvinyl pyrrolidone, polyacrylic acid, polymethacrylic acid and salts thereof, polyoxyethylene, acetyl cellulose, a mixture of acetyl celluloses having different acetyl values and the like.

Alternatively, it is possible to coat acetyl cellulose or a mixture of acetyl celluloses having different acetyl values on a porous membrane of an inorganic material having no hydrophilic group and then to subject the coated acetyl cellulose or a mixture of acetyl celluloses having different acetyl values to a saponification treatment. In that case, the saponification ratio is preferably about 5% or more and 100% or less. The saponification ratio is more preferably 10% or more and 100% or less.

Examples of the porous membrane of an inorganic material having no hydrophilic group include porous membranes prepared by processing aluminum and the like metals, glass, cement, pottery and the like ceramics, or new ceramics, silicon, activated carbon and the like.

It is desirable that the aforementioned nucleic acid adsorbing porous membrane can pass a solution through its inner part and has a thickness of from 10 μm to 500 μm. More preferably, the thickness is from 50 μm to 250 μm. Thinner thickness is desirable from the viewpoint of easy washing.

It is desirable that the aforementioned nucleic acid adsorbing porous membrane capable of passing a solution through its inner part has a minimum pore size of 0.22 μm or more. More preferably, the minimum pore size is 0.5 μm or more. In addition, it is desirable to use a porous membrane having a maximum pore size/minimum pore size ratio of 2 or more. By this ratio, a surface area sufficient for adsorbing nucleic acid can be obtained, and clogging hardly occurs. Further preferably, the maximum pore size/minimum pore size ratio is 5 or more.

It is desirable that the aforementioned nucleic acid adsorbing porous membrane capable of passing a solution through its inner part has a porosity of from 50 to 95%. Further desirably, the porosity is from 65 to 80%. Also, it is desirable that the bubble point is from 0.1 to 10 kgf/cm². Further desirably, the bubble point is from 0.2 to 4 kgf/cm².

It is desirable that the aforementioned nucleic acid adsorbing porous membrane capable of passing a solution through its inner part has a pressure loss of from 0.1 to 100 kPa. By this range, uniform pressure is obtained at the time of overpressure. Further desirably, the pressure loss is from 0.5 to 50 kPa. In this connection, the pressure loss is the lowest pressure necessary for passing water through a membrane having a thickness of 100 μm.

It is desirable that the aforementioned nucleic acid adsorbing porous membrane capable of passing a solution through its inner part has a percolation quantity of from 1 to 5,000 ml per 1 cm² membrane per 1 minute when water is passed at 25° C. under a pressure of 1 kg/cm². Further desirably, the percolation quantity is from 5 to 1,000 ml per 1 cm² membrane per 1 minute when water is passed at 25° C. under a pressure of 1 kg/cm².

It is desirable that the aforementioned nucleic acid adsorbing porous membrane capable of passing a solution through its inner part has a nucleic acid adsorbing amount of 0.1 μg or more per 1 mg porous membrane. Further desirably, the nucleic acid adsorbing amount is 0.9 μg or more per 1 mg porous membrane.

It is desirable that the aforementioned nucleic acid adsorbing porous membrane capable of passing a solution through its inner part is a cellulose derivative which, when a square porous membrane having a side of 5 mm is soaked in 5 ml of trifluoroacetic acid, does not dissolve within 1 hour but dissolves within 48 hours. Also desirable is a cellulose derivative which, when a square porous membrane having a side of 5 mm is soaked in 5 ml of trifluoroacetic acid, dissolves within 1 hour but does not dissolve within 24 hours when soaked in 5 ml of dichloromethane.

When a sample solution containing nucleic acid is passed through the nucleic acid adsorbing porous membrane, it is desirable to pass the sample solution from one side to the other side from the viewpoint that the solution can be uniformly contacted with the porous membrane. When a sample solution containing nucleic acid is passed through a nucleic acid adsorbing porous membrane having a front surface and a back surface asymmetrical with each other, it is desirable to pass the sample solution from a surface where pore size of the nucleic acid adsorbing porous membrane is large to a surface having small pore size, from the viewpoint that clogging hardly occurs.

When a sample solution containing nucleic acid is passed through the nucleic acid adsorbing porous membrane, it is desirable that its flow rate is from 2 to 1,500 μl/sec per cm² of membrane area, in order to obtain proper contacting time of the solution to the porous membrane. Sufficient separation purification effect cannot be obtained when contacting time of the solution to the porous membrane is too short, and too long time is not desirable from the handling point of view. It is more desirable that the aforementioned flow rate is from 5 to 700 μl/sec per cm² of membrane area.

In addition, the nucleic acid adsorbing porous membrane capable of passing a solution to be used through its inner part may be a single sheet, but two or more sheets can also be used. Two or more sheets of the nucleic acid adsorbing porous membrane may be the same or different from one another.

Two or more sheets of the nucleic acid adsorbing porous membrane may be a combination of a nucleic acid adsorbing porous membrane of an inorganic material with a nucleic acid adsorbing porous membrane of an organic material. For example, a combination of a glass filter with a porous membrane of regenerated cellulose can be cited. In addition, two or more sheets of the nucleic acid adsorbing porous membrane may be a combination of a nucleic acid adsorbing porous membrane of an inorganic material with a nucleic acid non-adsorbing porous membrane of an organic material. For example, a combination of a glass filter with a porous membrane of nylon or polysulfone can be cited.

A cartridge for separation and purification of nucleic acid prepared by receiving the aforementioned nucleic acid adsorbing porous membrane capable of passing a solution through its inner part in a container having at least two openings can be suitably used. In addition, a cartridge for separation and purification of nucleic acid prepared by receiving two or more sheets of the aforementioned nucleic acid adsorbing porous membrane capable of passing a solution through its inner part in a container having at least two openings can also be suitably used. In that case, the two or more sheets of nucleic acid adsorbing porous membrane to be received in a container having at least two openings may be the same or different from one another.

It is desirable that the cartridge for separation and purification of nucleic acid does not contain other members, except for containing the aforementioned nucleic acid adsorbing porous membrane capable of passing a solution through its inner part in a container having at least two openings. As the material of the aforementioned container, polypropylene, polystyrene, polycarbonate, polyvinyl chloride and the like plastics can be used. In addition, a biodegradable material can also be used desirably. Also, the aforementioned container may be either transparent or colored.

As the cartridge for separation and purification of nucleic acid, a cartridge for separation and purification of nucleic acid equipped with a means for discriminating individual cartridge for separation and purification of nucleic acids can be used. Examples of the means for discriminating individual cartridge for separation and purification of nucleic acids include bar code, magnetic tape and the like.

In addition, also can be used is a cartridge for separation and purification of nucleic acid which has such a structure that the nucleic acid adsorbing porous membrane can be taken out from the container having at least two openings.

The washing step is described in the following. By carrying out the washing, recovery yield and purity of nucleic acid are improved, and the amount of an analyte containing necessary nucleic acid can be reduced to a very small amount. In addition, automation of the washing and recovery operation renders possible convenient and quick operation. The washing step may be effected by one washing for the acceleration of the washing and recovery operation, but it is desirable to repeat two or more washing when purity is more important.

In the washing step, a washing solution is supplied into the cartridge for separation and purification of nucleic acid receiving nucleic acid adsorbing porous membrane making use of a tube, a pipette, an automatic injection device or other supplying means having the same function. The supplied washing solution is supplied from a first opening of the cartridge for separation and purification of nucleic acid (the opening from which a nucleic acid-containing sample solution was injected), allowed to pass trough the nucleic acid adsorbing porous membrane by making inside of the cartridge for separation and purification of nucleic acid into a pressurized state using a pressure difference producing device (e.g., a dropper, an injector, a pump, a power pipette or the like) connected to said opening, and then discharged from another opening different from the first opening. Also, it is possible to supply the washing solution from the first opening and discharge it from the same first opening. In addition, it is possible to supply and discharge the washing solution from an opening different from the first opening of the cartridge for separation and purification of nucleic acid from which the sample solution containing nucleic acid was supplied. However, the method in which the washing solution is supplied from the first opening of the cartridge for separation and purification of nucleic acid, allowed to pass through the nucleic acid adsorbing porous membrane and then discharged from an opening different from the first opening is more desirable because of the superior washing efficiency.

It is desirable that the amount of the washing solution in the washing step is 2 μl/mm² or more. Washing effect is improved when the amount of the washing solution is large. However, the operability can be maintained and outflow of sample can be prevented when it is set to 200 μl/mm² or less, which is desirable.

In the washing step, flow rate of the washing solution when passed through the nucleic acid adsorbing porous membrane is preferably from 2 to 1,500 μl/sec, more preferably from 5 to 700 μl/sec, per unit area (cm²) of the membrane. The washing can be sufficiently carried out when time is spent by reducing the passing rate. However, the separation purification operation of nucleic acid can be quickened without reducing the washing efficiency by employing the aforementioned range, which is desirable.

In the washing step, it is desirable that temperature of the washing solution is from 4 to 70° C. It is more desirable to set temperature of the washing solution to room temperature. In addition, in the washing step, it is possible to apply stirring to the cartridge for separation and purification of nucleic acid by a mechanical vibration or an ultrasonic wave, simultaneously with the washing step. Alternatively, the washing can be effected by carrying out centrifugation.

In the washing step, it is desirable that the washing solution is a solution which contains a water-soluble soluble organic solvent and/or a water-soluble salt. It is necessary that the washing solution has a function to wash out impurities in the sample solution adsorbed to the nucleic acid adsorbing porous membrane together with nucleic acid. To effect this, it is necessary that the solution has such a composition that it does not desorb nucleic acid from the nucleic acid adsorbing porous membrane but desorbs impurities. For this purpose, being slightly soluble for nucleic acid, an alcohol or the like water-soluble organic solvent is suitable for desorbing components other than nucleic acid while keeping nucleic acid. In addition, since the nucleic acid desorption effect is improved by the addition of a water-soluble salt, the action for selectively removing impurities and unnecessary components is improved.

As the water-soluble organic solvent to be contained in the washing solution, an alcohol, acetone and the like can be used, of which an alcohol is desirable. As the alcohol, methanol, ethanol, isopropanol, n-isopropanol, butanol, acetone and the like can be used, and it is particularly desirable to use ethanol. These alcohols can also be used as a mixture of two or more. Amount of the water-soluble organic solvent to be contained in the washing solution is preferably from 20 to 100% by weight, more preferably from 40 to 80% by weight.

On the other hand, it is desirable that the water-soluble salt to be contained in the washing solution is a salt of a halide, and a chloride is particularly desirable. In addition, the water-soluble salt is preferably a monovalent or divalent cation, particularly an alkali metal salt or an alkaline earth metal salt, of which a sodium salt or potassium salt is desirable and a sodium salt is most desirable.

When a water-soluble salt is contained in the washing solution, its concentration is preferably 10 mM or more, and its upper limit is not particularly limited with the proviso that it is within such a range that the solubility of impurities is not spoiled, but is preferably 1 M or less, more preferably 0.1 M or less. More preferably, the water-soluble salt is sodium chloride, and it is particularly desirable that sodium chloride is contained in an amount of 20 mM or more.

It is desirable that the washing solution does not contain a chaotropic substance. By this, a possibility of causing contamination with the chaotropic substance in the recovery step after the washing step can be reduced. When contamination with a chaotropic substance occurs at the recovery step, it sometimes inhibits PCR and the like enzyme reactions, so that it is ideal when the subsequent enzyme reaction and the like are taken into consideration that the washing solution does not contain chaotropic substances. In addition, since chaotropic substances are hazardous because of its corrosiveness, the operation without using a chaotropic substance is markedly advantageous for researchers from this point of view too, in terms of safe test operations. In this connection, the chaotropic substances are urea, guanidine salts, sodium isocyanate, sodium iodide, potassium iodide and the like as described in the foregoing.

Since the washing solution has high wettability for a cartridge or the like container, the washing solution sometimes remains in the container during the washing step in the nucleic acid separation purification process, so that the recovery step after the washing step is contaminated with the washing solution to cause reduction of the purity of nucleic acid and reduction of the reactivity in the subsequent step. Thus, when adsorption and desorption of nucleic acid are carried out using a cartridge or the like container, it is important that a solution to be used in the adsorption or washing, particularly the washing solution, does not remain in the cartridge so that it does not exert influence upon the next step.

Accordingly, in order to prevent contamination of the recovering solution of the subsequent step with the washing solution of the washing step and thereby to keep residue of the washing solution in the cartridge to the minimum, it is desirable that surface tension of the washing solution is less than 0.035 J/m². When the surface tension is low, wettability of the washing solution for the cartridge is improved and volume of the remaining solution can be controlled.

However, the ratio of water can be increased in order to increase the washing efficiency, but in that case, surface tension of the washing solution is increased and amount of the remaining solution is increased. When surface tension of the washing solution is 0.035 J/m² or more, amount of the remaining solution can be controlled by increasing water repellency of the cartridge. By increasing water repellency of the cartridge, droplets are formed, and amount of the remaining solution can be controlled by flow down of the droplets. Examples of the method for increasing water repellency include coating of a water repellant such as silicon on the cartridge surface, kneading of a water repellant such as silicon at the time of the cartridge forming, and the like, though not limited thereto.

The washing step can be simplified making use of the nucleic acid adsorbing porous membrane of the invention. (1) Frequency of the washing solution passing through the nucleic acid adsorbing porous membrane may be reduced to once. (2) The washing step can be carried out at room temperature. (3) After the washing, the recovering solution can also be immediately injected into the cartridge. (4) It is possible also to combine one or two or more of the aforementioned (1), (2) and (3). In the related methods, a drying step was frequently required in order to quickly remove an organic solvent contained in the washing solution, but the nucleic acid adsorbing porous membrane to be used in the invention is a thin membrane so that the drying step can be omitted.

In the related nucleic acid separation purification methods, there is a problem in that the washing is frequently scattered and adhered to other parts while carrying out the washing step to cause contamination (pollution) of samples. Such a type of contamination in the washing step can be inhibited by devising shapes of the cartridge for separation and purification of nucleic acid in which the nucleic acid adsorbing porous membrane is received in a container having two openings and of the waste water container.

The following describes the step for recovering nucleic acid by desorbing it from the nucleic acid adsorbing porous membrane.

In the recovery step, a recovering solution is supplied into the cartridge for separation and purification of nucleic acid equipped with the nucleic acid adsorbing porous membrane making use of a tube, a pipette, an automatic injection device or other supplying means having the same function. The recovered solution is supplied from a first opening of the cartridge for separation and purification of nucleic acid (the opening from which a nucleic acid-containing sample solution was injected), allowed to pass trough the nucleic acid adsorbing porous membrane by making inside of the cartridge for separation and purification of nucleic acid into a pressurized state using a pressure difference producing device (e.g., a dropper, an injector, a pump, a power pipette or the like) connected to said opening, and then discharged from another opening different from the first opening. Also, it is possible to supply the recovering solution from the first opening and discharge it from the same first opening. In addition, it is possible to supply and discharge the recovering solution from an opening different from the first opening of the cartridge for separation and purification of nucleic acid from which the sample solution containing nucleic acid was supplied. However, the method in which the recovering solution is supplied from the first opening of the cartridge for separation and purification of nucleic acid, allowed to pass through the nucleic acid adsorbing porous membrane and then discharged from an opening different from the first opening is more desirable because of the superior recovering efficiency.

Desorption of nucleic acid can be carried out by controlling volume of the recovering solution based on the volume of sample solution containing nucleic acid prepared from an analyte. Amount of the recovering solution containing the separated and purified nucleic acid depends on the amount of the analyte used. In general, amount of the recovering solution frequently used is from several 10 to several 100 μl, but when amount of the analyte is extremely small, or it is desirable to separate and purify a large amount of nucleic acid on the contrary, amount of the recovering solution can be changed within the range of from several 1 μl to several 10 ml

As the recovering solution, purified distilled water, Tris-EDTA buffer or the like can be suitably used. In addition, when the recovered nucleic acid is subjected to PCR (polymerase chain reaction), a buffer solution to be used in the PCR (e.g., an aqueous solution containing KCl 50 mmol/l, Tris-HCl 10 mmol/l and MgCl₂ 1.5 mmol/l as final concentrations) can also be used.

It is desirable that pH of the recovering solution is from pH 2 to 11. It is more desirably from pH 5 to 9. In addition, ionic strength and salt concentration particularly exert effect on the elution of adsorbed nucleic acid. It is desirable that the recovering solution has an ionic strength of 290 mmol/l and a salt concentration of 90 mmol/l. By doing this, recovery ratio of nucleic acid is improved and more amount of nucleic acid can be recovered. The recovered nucleic acid may be either single-stranded or double-stranded.

A recovering solution containing concentrated nucleic acid can be obtained by reducing volume of the recovering solution in comparison with the volume of the original sample solution containing nucleic acid. Preferably, (volume of recovering solution):(volume of sample solution)=from 1:100 to 99:100, and more preferably, (volume of recovering solution):(volume of sample solution)=from 1:10 to 9:10. By this, nucleic acid can be conveniently concentration without carrying out an operation for concentration at the after-step of the nucleic acid separation purification. By these methods, a method for obtaining a nucleic acid solution in which the nucleic acid is concentrated than the analyte can be provided.

In addition, as another method, a recovering solution containing a desired concentration of nucleic acid can be obtained, and a recovering solution containing a concentration of nucleic acid suited for the next step (PCR or the like) can be obtained, by carrying out desorption of nucleic acid under such a condition that volume of the recovering solution becomes larger than the volume of the original sample solution containing nucleic acid. Preferably, (volume of recovering solution):(volume of sample solution)=from 1:1 to 50:1, and more preferably, (volume of recovering solution):(volume of sample solution)=from 1:1 to 5:1. By this, a merit, namely avoidance of the troublesome concentration adjustment after the separation and purification of nucleic acid, can be obtained. In addition, increase of the nucleic acid recovery ratio from the porous membrane can be made by the use of sufficient amount of the recovering solution.

Also, nucleic acid can be conveniently recovered by changing temperature of the recovering solution in response to the purpose. For example, a nucleic acid solution can be obtained conveniently and efficiently, by preventing degradation of nucleic acid through the inhibition of the action of nuclease without adding a certain reagent or a special operation capable of inhibiting enzymatic degradation, by carrying out desorption of nucleic acid from the porous membrane after changing temperature of the recovering solution from 0 to 10° C.

Also, when temperature of the recovering solution is set to 10 to 35° C., recovery of nucleic acid at general room temperature can be carried out and the nucleic acid can be separated and purified by desorbing it without requiring a complex step.

In addition, as another method, desorption of nucleic acid from the porous membrane can be carried out conveniently with high recovery ratio without mediating a complicated operation, by shifting temperature of the recovering solution to a high temperature of, for example, from 35 to 70° C.

The number of times of injection of the recovering solution is not limited, and it may be once or two or more times. In general, this is carried out by single recovery when nucleic acid is separated and purified quickly and conveniently, but when a large amount of nucleic acid is recovered, the recovering solution is injected two or more times in some cases.

In the recovery step, it is possible to make the recovering solution of nucleic acid into a composition which can be used in the after-step thereafter. The separated and purified nucleic acid is sometimes amplified by the PCR (polymerase chain reaction) method. In that case, the separated and purified nucleic acid solution must be diluted with a buffer solution suited for the PCR method. By using a buffer solution suited for the PCR method in the recovery step by this method, it can be shifted to the subsequent PCR step conveniently and quickly.

Also, in the recovering step, it is possible to add a stabilizing agent for preventing degradation of the nucleic acid recovered in the recovering solution of nucleic acid. As the stabilizing agent, an antibacterial agent, a fungicide, a nucleic acid degradation inhibitor and the like can be added. As the nuclease inhibitor, EDTA and the like can be cited. In addition, as another embodiment, a stabilizer can also be added to the recovery container in advance.

Also, the recovery container to be used in the recovery step is not particularly limited, a recovery container prepared from a raw material having no absorption at 260 nm can be used. In that case, concentration of the recovered nucleic acid solution can be measured without transferring it into other container. As the raw material having no absorption at 260 nm, quartz glass and the like can for example be used, though not limited thereto.

It is desirable that the step for separating and purifying nucleic acid from an analyte containing nucleic acid, using the aforementioned cartridge for separation and purification of nucleic acid in which the nucleic acid adsorbing porous membrane is received in a container having at least two openings and the pressure producing device, is carried out using an automatic device which can carry out the step automatically. By this, not only the operation can be carried out conveniently and quickly, but also it becomes possible to obtain nucleic acid having a predetermined level independent of the skill of workers.

The following shows an example of the automatic device which can automatically carry out the step for separating and purifying nucleic acid from an analyte containing nucleic acid, using the aforementioned cartridge for separation and purification of nucleic acid in which the nucleic acid adsorbing porous membrane is received in a container having at least two openings and the pressure producing device, though the automatic device is not limited thereto.

The automatic device is a nucleic acid separation purification device that automatically carries out the separation purification actions using a cartridge for separation and purification of nucleic acid in which the nucleic acid adsorbing porous membrane capable of passing a solution through its inner part is contained, in which a sample solution containing nucleic acid is injected into said cartridge for separation and purification of nucleic acid, the nucleic acid in said sample solution is adsorbed to the aforementioned nucleic acid adsorbing porous membrane by pressurization, and then a recovering solution is dispensed into the aforementioned cartridge for separation and purification of nucleic acid and the nucleic acid adsorbed to the nucleic acid adsorbing porous membrane is desorbed and recovered together with the recovering solution, characterized in that it comprises the aforementioned cartridge for separation and purification of nucleic acid, the aforementioned waste water container for containing the aforementioned sample solution and washing solution, and a loading mechanism which keeps the aforementioned recovering container for containing the nucleic acid-containing recovering solution, a pressurized air supplying mechanism for introducing pressurized air into the aforementioned cartridge for separation and purification of nucleic acid and a dispensing mechanism for dispensing for dispensing the washing solution and recovering solution into the aforementioned cartridge for separation and purification of nucleic acid.

### EXAMPLES

The following describes the invention further illustratively based on examples, but the invention is not limited thereto.

1 Saponification Treatment of Porous Membrane

Using a porous membrane having a mixing ratio of triacetyl cell lose and diacetyl cellulose of 6:4 as the mixture of acetyl celluloses having different acetyl degree, porous membranes (membrane diameter=7 mm, membrane thickness=70 μm, average pore size=2.5 μm (calculated by Bubble Point Method of JIS K 3832)) having different degree of saponification were prepared by changing concentration of an alkali (saponification treatment with 0 to 1.0 N alkali aqueous solution).

As porous membranes of other than acetyl cellulose, raw materials of regenerated cellulose and polyethylene were used.

2 Measurement of Contact Angle of Porous Membrane

Using the aforementioned membranes in which the degree of surface treatment was changed, measurement of the contact angle was carried out under the following conditions.

The prepared porous membranes and their contact angles are shown in Table 1.

Regarding the measurement of the contact angle, each porous membrane was put on the horizontal stage of a solid-liquid interface analyzer (mfd. by Kyowa Kaimen Kagaku), 3 μl of purified water was dropped thereon, and the contact angle 17 m seconds after contact of the droplet was measured.

TABLE 1

| Kinds of membrane | Contact angle (°) |
|---|---|
| TAC untreated membrane | 107.5 |
| O N NaOH treatment | 94.6 |
| 0.05 N NaOH treatment | 87.6 |
| 0.5 N NaOH treatment | 47.7 |
| 1.0 N NaOH treatment | 43.3 |
| Regenerated cellulose | 26.5 |
| Polyethylene | 76.0 |

3 Preparation of Cartridge for Separation and Purification of Nucleic Acid

A container for a cartridge for separation and purification of nucleic acid, having an inner diameter of 7 mm and an area for containing a nucleic acid adsorbing porous membrane, was prepared using high impact polystyrene. The aforementioned porous membrane in which the degree of saponification was changed was received in the area of the container for the cartridge for separation and purification of nucleic acid, arranged for containing a nucleic acid adsorbing porous membrane, and used as the cartridge for separation and purification of nucleic acid.

4 Preparation of Nucleic Acid Solubilizing Reagent and Washing Solution

A nucleic acid solubilizing reagent and a washing solution having the formulations shown in Table 2 and Table 3 were prepared.

TABLE 2
(Nucleic acid solubilizing reagent solution)

| | | |
|---|---|---|
| Guanidine hydrochloride (mfd. by Life Technology) | 382 | g |
| Tris (mfd. by Life Technology) | 12.1 | g |
| Triton X-100 (mfd. by ICN) | 10 | g |
| Distilled water | 1,000 | ml |

TABLE 3
(Washing solution)

100 mM NaCl
10 mM Tris-HCl
65% Ethanol

5 DNA Separation Purification Operation

A 200 μl portion of the nucleic acid solubilizing reagent prepared in Example 1 and 20 μl of a protease (“Protease” Type XXIV Bacterial produced by SIGMA) solution were added to 200 μl of a human whole blood analyte and incubated at 60° C. for 10 minutes. After the incubation, 200 μl of ethanol was added thereto and stirred to prepare as sample solution containing nucleic acid. Said sample solution containing nucleic acid was injected into the first opening of the cartridge for separation and purification of nucleic acid prepared in the aforementioned (1) equipped with the nucleic acid adsorbing porous membrane of saponification product of a mixture of acetyl celluloses having different acetyl values, allowed to contact with the aforementioned nucleic acid adsorbing porous membrane by connecting a pressure producing device to the aforementioned first opening, thereby making inside of the cartridge for separation and purification of nucleic acid into a pressurized state, and allowing the injected sample solution containing nucleic acid to pass through the aforementioned nucleic acid adsorbing porous membrane, and then discharged from the other opening of the cartridge for separation and purification of nucleic acid. Next, the washing solution prepared in Example 1 was injected into the aforementioned first opening of the aforementioned cartridge for separation and purification of nucleic acid, and the injected washing solution was allowed to pass through the aforementioned nucleic acid adsorbing porous membrane by connecting the pressure producing device to the aforementioned first opening of the aforementioned cartridge for separation and purification of nucleic acid, thereby making inside of the cartridge for separation and purification of nucleic acid into a pressurized state, and then discharged from the other opening. This operation was repeated three times. Thereafter, the recovering solution was injected into the aforementioned first opening of the aforementioned cartridge for separation and purification of nucleic acid, and the injected recovering solution was allowed to pass through the aforementioned nucleic acid adsorbing porous membrane by connecting the pressure producing device to the aforementioned first opening of the aforementioned cartridge for separation and purification of nucleic acid, thereby making inside of the cartridge for separation and purification of nucleic acid into a pressurized state, and then discharged from the other opening, and this solution was recovered.

6 Confirmation of Recovery Yield of DNA

By carrying out UV measurement using the recovered solution, amount of DNA contained in the recovered solution was calculated from the absorbance (OD) at 260 nm.

The values measured in Example 1 are shown in Table 4.

TABLE 4

| Kinds of membrane | Extracted amount of DNA (μg) |
|---|---|
| TAC untreated membrane | 1.39 |
| O N NaOH treatment | 1.69 |
| 0.05 N NaOH treatment | 1.58 |
| 0.5 N NaOH treatment | 3.60 |
| 1.0 N NaOH treatment | 4.54 |
| Regenerated cellulose | 5.14 |
| Polyethylene | 0.20 |

It can be seen from the results of Table 1 and Table 4 that sufficient amount of DNA can be recovered when a porous membrane having a surface contact angle of 60° or less, preferably a membrane of 50° or less, is used.

On the other hand, it can be seen that the DNA yield is sharply reduced when a membrane having a surface contact angle of larger than 60° is used.

### INDUSTRIAL APPLICABILITY

Nucleic acid can be recovered with high yield and high purity in accordance with the invention by carrying out adsorption and desorption of nucleic acid by using a nucleic acid adsorbing porous membrane having a hydrophilic property of 60° in surface contact angle of water.

The entire disclosure of each and every foreign patent application from which the benefit of foreign priority has been claimed in the present application is incorporated herein by reference, as if fully set forth.

1. A method for separating and purifying a nucleic acid, which comprises:
(1) adsorbing the nucleic acid to a nucleic acid adsorbing porous membrane by passing a sample solution containing the nucleic acid through the nucleic acid adsorbing porous membrane;
(2) washing the nucleic acid adsorbing porous membrane by passing a washing solution through the nucleic acid adsorbing porous membrane, while the nucleic acid is adsorbed to the nucleic acid adsorbing porous membrane; and
(3) desorbing the nucleic acid from the nucleic acid adsorbing porous membrane by passing a recovering solution through the nucleic acid adsorbing porous membrane,
wherein the nucleic acid adsorbing porous membrane is a porous membrane that has a contact angle of 60° or less after 17 m seconds of contact of the porous membrane with 3 μl of water dropped to the porous membrane.

2. The method for separating and purifying a nucleic acid according to claim 1,
wherein the porous membrane has a contact angle of 50° or less.

3. The method for separating and purifying a nucleic acid according to claim 1,
wherein the nucleic acid adsorbing porous membrane is a porous membrane comprising an organic polymer to which the nucleic acid is adsorbed by a weak interaction involving substantially no ionic bond.

4. The method for separating and purifying a nucleic acid according to claim 1,
wherein the nucleic acid adsorbing porous membrane is a porous membrane comprising an organic polymer having a hydroxyl group.

5. The method for separating and purifying a nucleic acid according to claim 4,
wherein the nucleic acid adsorbing porous membrane is a porous membrane obtained by saponification of a mixture of acetyl celluloses different from each other in acetyl value.

6. The method for separating and purifying a nucleic acid according to claim 1,
wherein the nucleic acid adsorbing porous membrane has a front surface and a back surface asymmetrical with each other.

7. The method for separating and purifying a nucleic acid according to claim 6,
the nucleic acid adsorbing porous membrane has a larger average pore size on the front surface than an average pore size on the back surface.

8. The method for separating and purifying a nucleic acid according to claim 1,
wherein the sample solution containing a nucleic acid is a solution where a water-soluble organic solvent is added to a solution obtained by treating a cell or virus-containing analyte with a nucleic acid solubilizing reagent.

9. The method for separating and purifying a nucleic acid according to claim 8,
wherein the nucleic acid solubilizing reagent is a solution containing at least one of a chaotropic salt, a surface active agent, a proteolytic enzyme, an antifoaming agent and a reducing agent.

10. The method for separating and purifying a nucleic acid according to claim 8,
wherein the water-soluble organic solvent is at least one alcohol selected from methanol, ethanol, propanol and an isomer thereof, and butanol and an isomer thereof.

11. The method for separating and purifying a nucleic acid according to claim 1,
wherein the washing solution is a solution containing at least one of methanol, ethanol, propanol and an isomer thereof, and butanol and an isomer thereof in a total amount of 20 to 100% by weight.

12. The method for separating and purifying a nucleic acid according to claim 1,
wherein the recovering solution is a solution having a salt concentration of 0.5 M or less.

13. The method for separating and purifying a nucleic acid according to claim 1, which uses a cartridge for separation and purification of nucleic acid,
wherein the cartridge for separation and purification of nucleic acid comprises:
a container having at least two openings; and
a nucleic acid adsorbing porous membrane being received in the container.

14. The method for separating and purifying a nucleic acid according to claim 1,
wherein the sample solution containing a nucleic acid, the washing solution or the recovering solution is passed through the nucleic acid adsorbing porous membrane by using a pressure difference producing device.

15. A device for carrying out a method for separating and purifying a nucleic acid according to claim 1.

16. A reagent kit for carrying out a method for separating and purifying a nucleic acid according to claim 1.
